(19) United States
(12) Patent Application Publication
(10) Pub. No.: US 2004/0006705 A1
(43) Pub. Date: Jan. 8, 2004

(54) Secure two-message synchronization in wireless networks

(76) Inventor: Jesse R. Walker, Portland, OR (US)

Correspondence Address: Timothy N. Trop, TROP, PRUNER & HU, P.C., STE 100, 8554 KATY FWY, HOUSTON, TX, 77024-1841, US

(21) Appl. No.: 10/189,843

(22) Filed: Jul. 5, 2002

(51) Int. Cl. H04L 9/00

(52) U.S. Cl. 713/200

(57) ABSTRACT

In a wireless network, secure synchronization may be achieved with two messages. A beacon initiator may provide a beacon timestamp field and a beacon nonce to devices in the network. A device in the network that wishes to synchronize with another device may send a message containing a variety of parameters including the beacon timestamp field and the nonce. Upon receipt, the receiving device can check a key included in the message, the beacon timestamp field and the nonce to determine, not only that the sender has a valid key, but that the message has a valid time so that one can be reasonably sure that the message was not simply copied. The receiving device then sends a message response which contains verifiable parameters to enable the message sender to be sure that the sender is communicating with a valid receiver.

### BACKGROUND

This invention relates generally to networks which are established pursuant to wireless protocols.

A variety of wireless protocols enable short-range wireless networks between processor-based and non-processor-based systems. A station in one network may be mobile and may be moved from area to area so that it eventually interacts with one or more networks. Before a network may wish to communicate with an in-range mobile station, a network may wish to authenticate the mobile station to ensure that network security will not be compromised as a result of such communications.

Thus, it would be desirable to have a relatively simple way to enable wireless devices to communicate with one another in a secure fashion.

### BRIEF DESCRIPTION OF THE DRAWINGS

FIG. 1 is a schematic depiction of one embodiment of the present invention; and

FIG. 2 is a flow chart for one embodiment of the present invention.

### DETAILED DESCRIPTION

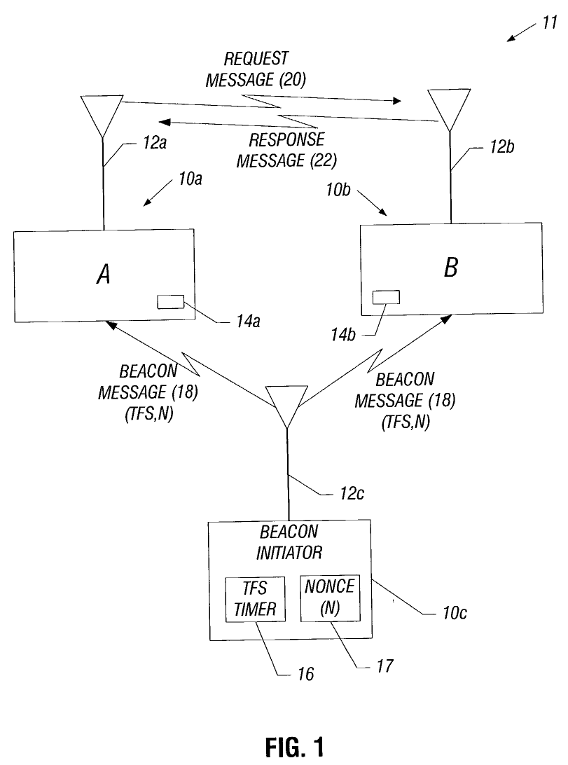

Referring to FIG. 1, a network 11 may include at least two devices 10a and 10b that communication over an appropriate wireless protocol. In one embodiment, that wireless protocol may be the IEEE 802.11 protocol. (ANSI/IEEE Std. 802.11, 1999 Edition), IEEE Standards Board, Piscataway, N.Y. 08855. Each device 10 may include an antenna 12 that may, for example, be a dipole antenna.

Each communicating party 10a or 10b may be part of the same network. The parties 10a and 10b may be a station and an access point or they may be a pair of stations in an ad hoc network or a side-band channel or repeater, to mention a few examples. A wireless communication channel between the devices 10a and 10b.

Each of the devices 10a and 10b may receive a beacon frame or message 18 from a beacon initiator 10c. Like the devices 10a and 10b, the beacon initiator 10c may be any wireless device including a station, an access point, a side-band channel or repeater, to mention a few examples. The beacon initiator 10c may generate a beacon with a beacon timestamp field containing a copy of the timer syncronization function (TSF) 16 and nonce (N) 17. The beacon initiator 10c may simply be a party that produces beacon messages pursuant to an 802.11 protocol. Each beacon message announces important protocols for the network and is typically broadcast to all the members of the network. Among the beacon parameters is a common notation of time, represented by the TFS 16. For example, devices in an 802.11 network may synchronize to the network's notion of time within 4 microseconds.

In accordance with one embodiment of the present invention, the beacon message 18 may also include a nonce “N” 17. The beacon initiator 10c may establish its nonce 17 whenever it initializes and the initiator 10c uses its nonce 17 until the initiator 10c again reinitializes in one embodiment. The nonce 17 may be selected so it is never reused across any reinitialization of the beacon initiator 10c in one embodiment. Thus, the nonce value may be a real time wall clock value, a randomly generated value, or some other value that is not reused until the crytographic key used to protect the message exchanges is changed.

When the device 10a wishes to establish a synchronized state with the device 10b, the device 10a consults the latest beacon message 18 to learn the present TFS 16 and beacon nonce 17. The device 10a then formulates a request message 20 to the device 10b. The request message 20, in one embodiment, may include the identity of the device 10a (“id_{A}”), the identity of device 10b (“id_{B}”), the state (“s”) that the device 10a wishes to synchronize to, its notion of time (“T”) based on the TFS 16, the beacon nonce (“N”) 17, the randomly generated nonce (“N_{A}”) from the device 10a and an electronic signature. The signature may be computed as a message integrity code (MIC).

A cryptographically secure message integrity code can be used to sign data messages sent over an 802.11 channel. Examples of MICs include Hashing for Message Authentication-Secure Hash Algorithm (HMAC-SHA-1), See M. Bellare, et al., RFC 2104 (February 1997), Advanced Encryption Standard-Cipher Blocking Chaining-Message Authentication Code (AES-CBC-MAC), and Parallelizable MAC (PMAC). Any MIC may be used in accordance with some embodiments of the present invention.

The devices 10a and 10b may share a key (“K”) utilized for data authentication. The key may be derived from a password, may be dynamically assigned, or may be generated in some other fashion. Generally, it is desirable that the key be distributed in a secure manner so that it is unknown to possible adversaries.

Thus, in one embodiment, the signature may be computed as an MIC using the authentication key over the following data:

A to B: id_{A},id_{B},s,T,N,N_{A},MIC_{K}(id_{A},id_{B},s,T,N,N_{A})

The order of these message elements is immaterial, and some of the values may be implicit. In particular, the state s may be implicit or it may be only a reference to a state. It is, however, desirable in some embodiments that the device 10a's own nonce N_{A} be unpredictable and, also, never be repeated during the lifetime of the key K.

When the device 10b receives the request message 20, it shares the authentication K with the party identified by id_{A}. The device 10b then determines whether the request message's notion of time T matches its own. In other words, the device 10b determines whether the message 20 is sufficiently recent that the nonce N also matches the nonce presently used in beacon messages 18 and that the device 10b is the intended party in this synchronization protocol.

The device 10b also uses the authentication key to verify the MIC signature over the request message 22. If any of these checks fail, then the device 10b interprets the message as invalid and declines the request to synchronize the state s.

However, if all of these checks succeed, the device 10b interprets the request message as valid. The device 10b can treat the request as valid because it contains the time T and the beacon nonce N, identifying this request message 20 as a recently generated message and confirms that the data has been protected by the MIC. By assumption, the key K is unknown to any adversary and the MIC is cryptographically secure, so it is computationally infeasible for an adversary to produce the message in the required time frame.

When it receives a valid synchronization request message 20, the device 10b formats and returns the response message 22. The response message 22 may be similar to the request message 20, except it may not include the time T and the beacon nonce N in one embodiment:

B to A: id_{A},id_{B},s,N_{A},MIC_{K}(id_{A},id_{B},s,N_{A})

When the device 10a receives the message 22, it verifies that the response matches the request message 20 and that the message's MIC is correct. In particular, the device 10a verifies the timeliness of the request message 22 by checking the response message 22 including the nonce N_{A}. If the request message 22 passes these tests, then the device 10a knows that it has synchronized the state s with the device 10b. Moreover, it has done so with only two messages in some embodiments.

As indicated in FIG. 1, each device 10a or 10b may include a storage 14a or 14b that may store code or software for implementing the secure two message synchronization protocol just described. In other embodiments the secure two message synchronization protocol may be implemented in hardware or logic.

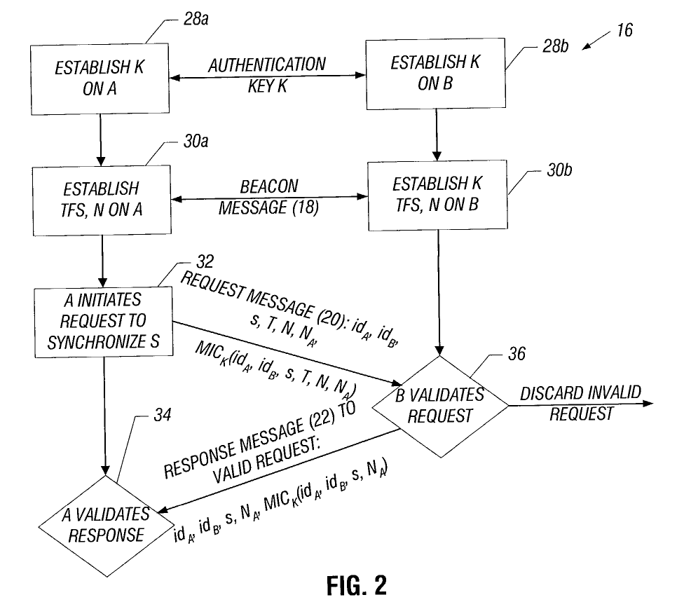

Thus, referring to FIG. 2, initially, on the left side, the device 10a establishes K, as indicated in block 28a. Similarly, the device 10b establishes K, as indicated in block 28b. Thus, both the devices 10a and 10b have the authentication key K.

Next, a beacon message 18 may be provided to both devices 10a and 10b. As a result, the TFS and the beacon nonce N may be established on each device 10, as indicated in blocks 30a and 30b. The device 10a, which is the message initiator, initiates a request message 20 to synchronize s, as indicated in block 32. As indicated by the arrow from block 32 to diamond 36, the request may include the parameters id_{A}, id_{B}, s, T, N, N_{A}, MIC_{K}(id_{A}, id_{B}, s, T, N, N_{A}).

When the request message 20 is received at device 10b, the device 10b validates the message 20, as indicated in diamond 36, and provides a response message 22 to any valid requests. The response message may include the parameters id_{A}, id_{B}, s, N_{A}, MIC_{K}(id_{A}, id_{B}, s, N_{A}). When the device 10a receives the response message 22, the device 10a validates the response, as indicated in diamond 34.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a wireless beacon including an indication of time; and
generating a wireless request message to establish secure synchronization with another device in a wireless network by sending a message including the indication of time.

2. The method of claim 1 including receiving a beacon with a timer synchronization function.

3. The method of claim 2 including generating a wireless request message that includes a nonce.

4. The method of claim 3 including generating a wireless request message that includes the timer synchronization function.

5. The method of claim 1 including receiving a unique nonce in a beacon message.

6. The method of claim 5 including establishing a synchronization state between two wireless devices on the wireless network.

7. The method of claim 6 including providing the identity of the first wireless device and the second wireless device in a request message sent to the second wireless device.

8. The method of claim 7 including generating a nonce at a first wireless device and including in the request message the nonce included with a beacon message and a nonce generated by the first wireless device.

9. The method of claim 8 including providing a secure key to said first and second devices.

10. The method of claim 9 including receiving a response message from said second wireless device.

11. The method of claim 10 including determining whether a request message that is received is sufficiently recent as to be considered authentic.

12. The method of claim 11 including using a nonce from the first wireless device to determine whether the request message is recent.

13. The method of claim 12 including identifying an authentication key in said request message and checking said authentication key.

14. The method of claim 13 including if the message is authentic, returning a response message.

15. The method of claim 14 including in said response message the identity of the first and second wireless devices.

16. The method of claim 15 including providing information about a synchronized state between said first and second wireless devices.

17. The method of claim 16 including returning a nonce received from said first wireless device to said first wireless device.

18. The method of claim 17 including providing a message integrity code to said first wireless device.

19. The method of claim 18 wherein said message integrity code includes data about the identities of the first and second wireless devices.

20. An article comprising a medium storing instructions that, if executed, enable a processor-based system to perform the steps of:
receiving a wireless beacon including an indication of time; and
generating a wireless request message to establish secure synchronization with another device in a wireless network by sending a message including the indication of time.

21. The article of claim 20 further storing instructions that, if executed, enable the processor-based system to perform the step of receiving a beacon with a timer synchronization function.

22. The article of claim 21 further storing instructions that, if executed, enable the processor-based system to perform the step of generating a wireless request message that includes a nonce.

23. The article of claim 22 further storing instructions that, if executed, enable the processor-based system to perform the step of generating a wireless request message that includes the timer synchronization function.

24. The article of claim 20 further storing instructions that, if executed, enable the processor-based system to perform the step of receiving a unique nonce in a beacon message.

25. The article of claim 24 further storing instructions that, if executed, enable the processor-based system to perform the step of establishing a synchronization state between two wireless devices on the wireless network.

26. The article of claim 25 further storing instructions that, if executed, enable the processor-based system to perform the step of providing the identity of the first wireless device and the second wireless device in a request message sent to the second wireless device.

27. The article of claim 26 further storing instructions that, if executed, enable the processor-based system to perform the step of generating a nonce at a first wireless device and including in the request message the nonce included with a beacon message and a nonce generated by the first wireless device.

28. The article of claim 20 further storing instructions that, if executed, enable the processor-based system to perform the step of providing a secure key to said first and second devices.

29. The article of claim 28 further storing instructions that, if executed, enable the processor-based system to perform the step of receiving a response message from said second wireless device.

30. The article of claim 29 further storing instructions that, if executed, enable the processor-based system to perform the step of determining whether a request message that is received is sufficiently recent as to be considered authentic.

31. The article of claim 30 further storing instructions that, if executed, enable the processor-based system to perform the step of using a nonce from the first wireless device to determine whether the request message is recent.

32. The article of claim 31 further storing instructions that, if executed, enable the processor-based system to perform the step of identifying an authentication key in said request message and checking said authentication key.

33. The article of claim 32 further storing instructions that, if executed, enable the processor-based system to perform the step of if the message is authentic, returning a response message.

34. The article of claim 33 further storing instructions that, if executed, enable the processor-based system to perform the step of in said response message the identity of the first and second wireless devices.

35. The article of claim 34 further storing instructions that, if executed, enable the processor-based system to perform the step of providing information about a synchronized state between said first and second wireless devices.

36. The article of claim 35 further storing instructions that, if executed, enable the processor-based system to perform the step of returning a nonce received from said first wireless device to said first wireless device.

37. The article of claim 36 further storing instructions that, if executed, enable the processor-based system to perform the step of providing a message integrity code to said first wireless device.

38. The article of claim 37 further storing instructions that, if executed, enable the processor-based system to perform the step wherein said message integrity code includes data about the identities of the first and second wireless devices.

39. A wireless device comprising:
a processor; and
a storage storing instructions that, if executed, enable the processor to perform the steps of:
receiving a wireless beacon including an indication of time; and
generating a wireless request message to establish secure synchronization with another device in a wireless network by sending a message including the indication of time.

40. The device of claim 39 wherein said storage further stores instructions that, if executed, enable the processor to perform the step of receiving a beacon with a timer synchronization function.

41. The device of claim 39 wherein said storage further stores instructions that, if executed, enable the processor to perform the step of generating a wireless request message that includes a nonce.

42. The device of claim 41 wherein said storage further stores instructions that, if executed, enable the processor to perform the step of generating a wireless request message that includes the time synchronization function.

43. The device of claim 39 wherein said storage stores instructions that, if executed, enable the processor to perform the step of receiving a unique nonce in a beacon message.

44. The device of claim 43 wherein said storage stores instructions that, if executed, enable the processor to perform the step of establishing a synchronization state with another wireless device on a wireless network.

45. The device of claim 44 wherein said storage further stores instructions that, if executed, enable the processor to perform the step of providing the identity of the wireless device and a second wireless device in a request message sent to the second wireless device.

46. The device of claim 20 further storing instructions that, if executed, enable the processor to perform the step of determining whether a request message that is received is sufficiently recent as to be considered authentic.

47. A wireless device comprising:
a processor;
a storage storing instructions that, if executed, enable the processor to perform the steps of:
receiving a wireless beacon including an indication of time; and
generating a wireless request message to establish secure synchronization with another device in a wireless network by sending a message including the indication of time; and
a dipole antenna coupled to said processor.

48. The device of claim 47 wherein said storage further stores instructions that, if executed, enable the processor to perform the step of receiving a beacon with a timer synchronization function.
